(19) United States
(12) Patent Application Publication
(10) Pub. No.: US 2014/0046731 A1
(43) Pub. Date: Feb. 13, 2014

(54) SYSTEMS AND METHODS FOR AN OUTCOME BASED PRICING

(71) Applicants: Sri Raghupathy, San Jose, CA (US); Rob J.F. Verboom, Bavel (NL); Anjali S. Deshpande, Milpitas, CA (US)

(72) Inventors: Sri Raghupathy, San Jose, CA (US); Rob J.F. Verboom, Bavel (NL); Anjali S. Deshpande, Milpitas, CA (US)

(21) Appl. No.: 13/572,600

(22) Filed: Aug. 10, 2012

(51) Int. Cl. G06Q 30/02

(52) U.S. Cl. 705/7.35

(57) ABSTRACT

Systems and methods for outcome based pricing may be useful in conjunction with an enterprise resource planning system in order to generate desired outcomes for a customer and provide optimized profitability for the vendor. Outcome based pricing is achieved by first generating a bundle of line items. The line items are selected from a listing of known goods and services, and each line item includes an output. The summation of the outputs for the bundle of line items achieves a desired outcome. The desired outcome includes a quantity value and a quality value, and is received from a customer. Next, the bundle of line items is priced to determine invoice price, pocket price and margin. More than one such bundle is generated for the desired outcome, each bundle containing different combinations of line items. The pricing for each of these bundles is compared to identify a preferred bundle.

### BACKGROUND

This invention relates generally to systems and methods to generate pricing based upon outcomes in a preferential manner. Such systems and methods enable vendors of goods and/or services to provide customers with solutions that meet the customer's needs while maximizing profits.

Traditionally, pricing is performed on a line item by line item basis. A customer will contact a vendor and request a particular number of widgets or services. The vendor then provides a cost per widget/unit of service. The determination of how many widgets or services required falls upon the customer, in these scenarios. Thus, risks associated with improper projections regarding scope of work are a burden born by the customer.

The benefit of these traditional mechanisms of pricing is that the vendor can readily formulate optimized prices based upon a set of items the customer desires. A number of Business to Business (B2B) pricing systems are available to maximize profits for these traditional methodologies.

However, many customers desire to receive not a particular good or service, but rather an expected outcome. In outcome based transactions the customer presents a desired result, and the vendor must deliver the outputs. Outcome based transactions have been employed in a number of industries for quite some time. Often industries where the vendor is far more sophisticated than the customer have been prime targets for outcome based transactions.

For example, in home renovations the customer desires a bathroom remodel. The vendor (in this example, a contractor) provides a quote for the entire remodel project. Seldom does the customer request a particular number of service hours and units of goods from the contractor, rather the contractor is relied upon to deliver the final remodeled room for an agreed upon price.

While outcome based transactions are known, pricing of such transactions, particularly real time pricing during negotiations, is not well developed. Typically a vendor relies upon industry knowledge and experience to estimate the size of a project. Returning to the remodel example above, an experienced contractor can readily enter a room and provide a reasonably accurate estimation of remodel costs based upon the desired outcome the customer has (high quality contemporary style for example).

However, even with an experienced vendor, pricing based upon outcomes is subject to estimation errors and as such requires overestimations in order to maintain profitability. This may undermine the ability for a vendor to remain competitive. Further, many industries where outcome based transactions are implemented may not have an equivalent experienced and skilled vendor capable of estimating scope of work. As such, pricing based upon outcomes is further complicated.

Some of these complications may be overcome by having an appropriate database of goods and services that are directed toward specific outcomes. However, even with such a dataset, no current systems are known which accomplish true outcome based pricing in a competitive and accurate manner.

It is therefore apparent that an urgent need exists for systems and methods for outcome based pricing which provides fast and accurate prices for a desired customer outcome. The generated pricing will provide customers with competitive pricing for a desired outcome, and optimizing profitability for the vendor.

### SUMMARY

To achieve the foregoing and in accordance with the present invention, systems and methods for outcome based pricing are provided. These systems and methods may be useful in conjunction with an enterprise resource planning system in order to generate desired outcomes for a customer and provide optimized profitability for the vendor.

In some embodiments, outcome based pricing is achieved by first generating a bundle of line items. The line items are selected from a listing of known goods and services, and each line item includes an output. The summation of the outputs for the bundle of line items achieves a desired outcome. The desired outcome includes a quantity value and a quality value, and is received from a customer. Next, the bundle of line items is priced to determine invoice price, pocket price and margin.

More than one such bundle is generated for the desired outcome, each bundle containing different combinations of line items. The pricing for each of these bundles is compared to identify a preferred bundle. In some cases, the preferred bundle is identified by an objective function which weights profitability of each bundle and overall price of each bundle. The preferred bundle is output to an enterprise resource management system, and its performance is monitored. In response to the performance monitoring, the output of each line item may be updated as more current data is available.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example schematic block diagram for a system in which outcome based transactions occur, in accordance with some embodiments;

FIG. 2 is an example schematic block diagram for an outcome based pricing system, in accordance with some embodiments;

FIGS. 3-5 are example flow charts for representative processes of providing outcome based pricing, in accordance with some embodiments;

FIGS. 6-12 are example screen shot illustrations for interfaces of the outcome based pricing system, in accordance with some embodiments; and

FIGS. 13A and 13B are example illustrations for computer systems configured to embody the outcome based pricing system, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The following discussion relates to methods and systems for outcome based pricing that provides the ability to engage in outcome based transactions in a manner which provides competitive pricing while maintaining optimal profits. Such a system may be utilized to rapidly develop a number of scenarios which meet the desired outcome and comparing these scenarios in real time to determine preferred means for meeting the customer's expectations. The system prices these preferred scenarios in any manner which ensures profitability for the vendor. Transactions by desired outcome using the systems and methods disclosed herein have the benefit of promoting efficiency in order to add value to both the consumer and the vendor.

Note that the following disclosure includes a series of subsections. These subsections are not intended to limit the scope of the disclosure in any way, and are merely for the sake of clarity and ease of reading. As such, disclosure in one section may be equally applied to processes or descriptions of another section if and where applicable.

Also note that particular consideration is made to the Business to Business (B2B) market, where large scale and complex transactions make outcome based pricing particularly beneficial. Despite this clear utility in the B2B markets, the disclosed methods can apply equally well to the Business to Consumer (B2C) markets, where applicable. Thus, the disclosure is intended to reflect the full gamut of transactions a business may engage in, even in circumstances where only type of transaction is being referenced, for clarity sake. Likewise, while a “vendor” is being referenced throughout this disclosure, the vendor may include not only a manufacturer, but also a management firm, middleman, or consultant service which either directly supplies the goods and/or services, or acts as an intermediary between the customer and principle supplier of the goods and/or services.

### I. Outcome Based Transaction Systems

Before delving too deeply into the embodiments of the outcome based pricing system it is important that outcome based transactions are properly understood. This provides perspective into the functioning, and unique features of the present outcome based pricing system.

When a customer purchases a good or service they are typically not desiring the specific good or service, but rather are purchasing the good or service in order to meet some desired outcome. This is particularly true where the goods and/or services are fungible or otherwise substitutable.

For example, an airline must purchase tires for its fleet. While the airline purchases tires, the desired outcome is to have safe landings. The airline does not care about model or make of the tire, as long as the tire meets their expectations of number of landings. Similarly, an organization may desire to enhance their computer network with more memory of bandwidth. The organization does not care if the memory is in 250 GB increments versus 1 TB drives. Similarly, bandwidth and latency are the desired outcomes, not specific units of hardware.

When an outcome is desired by a customer, it typically has to analyze how to meet the desired outcome in terms of goods and services required. The customer incurs risk that its analysis of the goods and services required is accurate. In outcome based pricing this risk is shifted from the customer to the vendor; thus making outcome based transactions attractive to many customers. As noted above, vendors have historically been ill equipped to respond accurately to outcome based transactions. The disclosed systems and methods overcome many of the hurdles to outcome based pricing in order to provide vendors the necessary tools to compete in these markets.

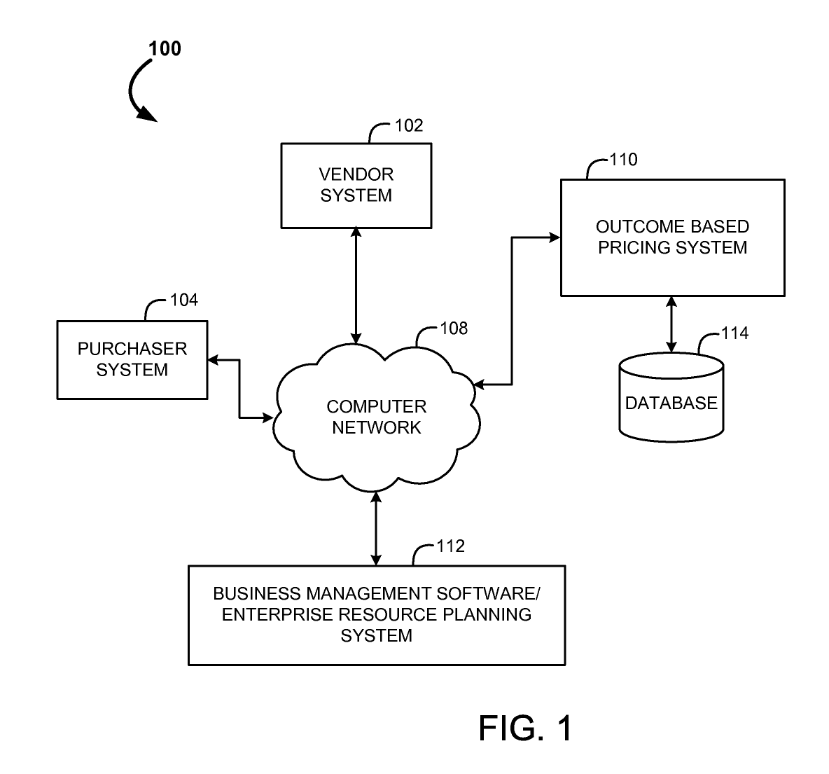

To facilitate this discussion, FIG. 1 illustrates an example schematic diagram for a system where outcome based transactions may occur, shown generally at 100. In this example, the vendor system 102 is illustrated in communication with the purchaser system 104 via a computer network 108. The computer network 108 is most typically the internet, but may also include any computer network including local area networks, corporate or industry wide area networks, or other hybrids of multiple networks (such as a wireless network in conjunction with the internet when employing mobile platforms).

The vendor system 102 may also access the outcome based pricing system 110 via the computer network 108. The outcome based pricing system 110 may couple to a database 114 which maintains data on goods and services in order to ensure that scenarios may be generated that accurately address the desired outcomes.

The outcome based pricing system 110 may provide pricing to a business management software 112 via the computer network 108. The business management software 112 may include any known enterprise platforms for negotiating and facilitation transactions, such as SAP ECC (ERP Central Component). The business management software 112 may function as a negotiation platform between the vendor system 102 and purchaser system 104 for the completion of the transaction.

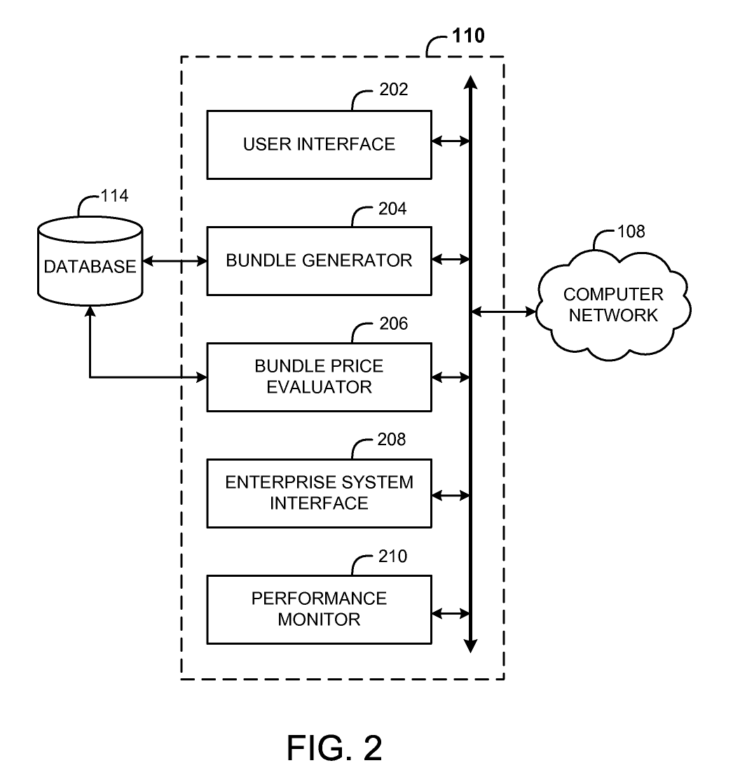

FIG. 2 illustrates a more detailed schematic diagram of the outcome based pricing system 110. In this example embodiment, the portions of the outcome based pricing system 110 may be interconnected via a central bus. The outcome based pricing system 110 may include a user interface 202, a bundle generator 204, a bundle price evaluator 206, an enterprise system interface 208 and a performance monitor 210. The bundle generator 204 and bundle price evaluator 206 may query the database 114 in order to generate the scenarios that meet the expected outcome for the customer.

In some embodiments, a set of desired outcomes is provided to the outcome based pricing system 110 from the consumer either directly or via the vendor. The desired outcomes include one or more conditions that must be met for the transaction. The database 114 includes an index of line items (including goods and services). In addition to identification of the line item, the database 114 includes information regarding line items cost, margin and output. For example, in some embodiments the database 114 may include line items for 100 watt, 60 watt and 40 watt halogen light bulbs. The database 114 may also include cost per bulb for each of the three bulbs, margin and lumen output of the bulbs. A retailer interested in procuring lighting may indicate the need for an aggregate lumen value for displays as a desired outcome. Thus, the database 114 may have the information in order to determine quantity of each of the bulbs which meet the expected outcome.

The bundle generator 204 may take the expected/desired outcome and compare it to the outputs stored in the database 114. When the bundle generator 204 finds matched between line items stored in the database 114 and the desired outcome, it generates a “bundle” of line items which in aggregate meet the desired outcome.

In our above example, suppose the retailer requires 200,000 lumens to illuminate a display case. The 100 watt bulb produces 1000 lumens, the 60 watt produces 500 lumens and the 40 watt bulb generates 250 lumens. Thus, line items for the desired outcome would include bundles for 200 quantity of 100 watt bulbs, 400 quantity of 60 watt bulbs and 800 quantity of 40 watt bulbs. However, the system would also be versatile enough to identify relational data (also stored within the database 114) in order to determine that a larger number of fixtures and cabling is required for wiring the lower wattage bulbs, as well as a greater quantity of electrician service hours in order to install and maintain the display. Relational data may be indexed to each line item to facilitate the generation of the bundles.

The bundle price evaluator 206 utilizes the invoice price and margin values of the line items bundles by the bundle generator 204 in order to calculate price. Each line item may be priced, and adjusted according to volume discounts and base price. Additionally, the bundle price evaluator 206 may build in a “premium” value into the bundle price which covers the added value the customer receives for shifting risk over to the vendor. The summed price for each bundle may be compared, as well as the margin for the bundle. The vendor may then select preferred bundle(s) for presentation to the customer. These preferred bundle(s) may be transferred, along with all pricing data, to the business management software 112 via the enterprise system interface 208. The business management software 112 may then complete the negotiations and transaction.

The performance of the bundle, once implemented may be monitored by the performance monitor 210. This performance monitoring may be for the entire bundle, or some component of the bundle. Performance may be utilized by the vendor to assist in selecting preferred bundles in future transactions, and/or may be utilized to update the output values indexed to each line item (as stored in the database 114). For example, returning to our previous hypothetical, the vendor and consumer determined that the 100 watt bulb bundle is most cost effective and provides a preferred profit structure for the vendor. After implementation the customer identifies that additional lumen are required, and 20 additional bulbs are installed. The performance monitor 210 may record these performance metrics and update the line item index that 100 watt bulbs produce fewer lumens than initially expected. In another example, the 100 watt bulbs may produce the desired lumens, but produce undesirable shadows. Thus, a combination of 100 watt bulbs and 40 watt bulbs could be utilized, in this illustrative example, in order to generate the desired outcome. These alterations may all be tracked by the performance monitor 210. For each such transaction, the performance monitoring is done based on actual input used compared against expected usage.

### II. Outcome Based Pricing Methods

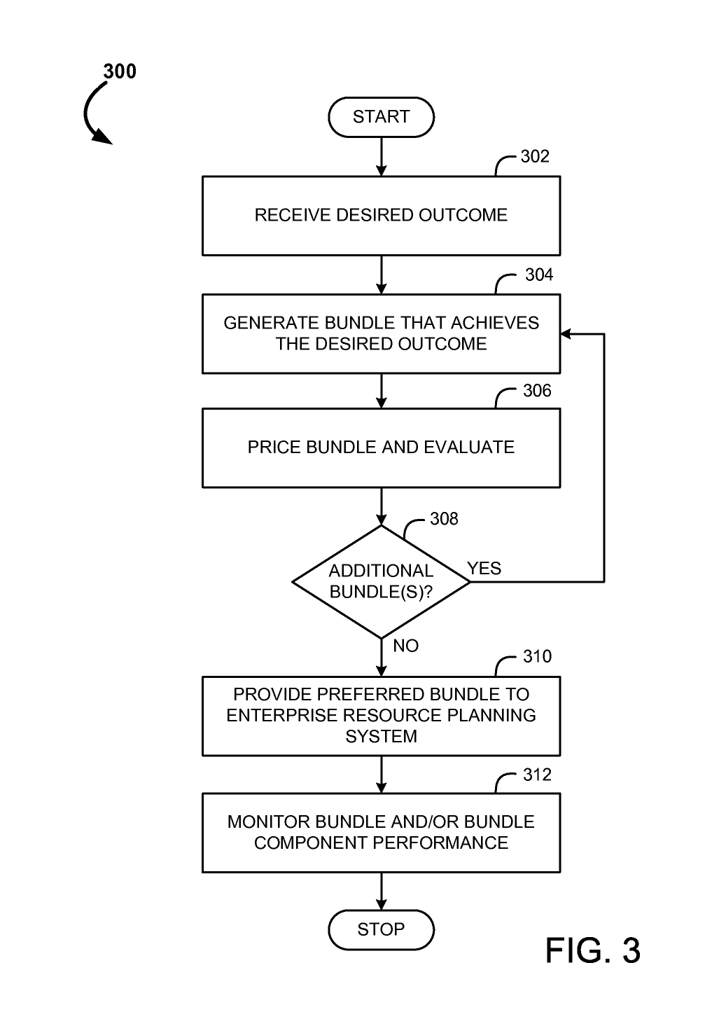

Now that the basic system architecture has been described, FIG. 3 is presented to illustrate methods for pricing based upon desired outcome, shown generally at 300. In this example flowchart, the desired outcome is first received (at 302) which includes one or more conditions that need to be met. These conditions, or desired outcomes, are the basis for the bundle of goods and services that the vendor will supply. The desired outcome may be highly varied, and may apply to virtually any facet of industry; including mining (i.e., removal of a volume of stone at a particular size), electronics and communication systems (i.e., increasing storage capability and bandwidth for a network), retail displays (i.e., lighting), aviation (i.e., number of landings for tire contracts), farming (i.e., harvest of a certain number of acres during a set time period), etc.

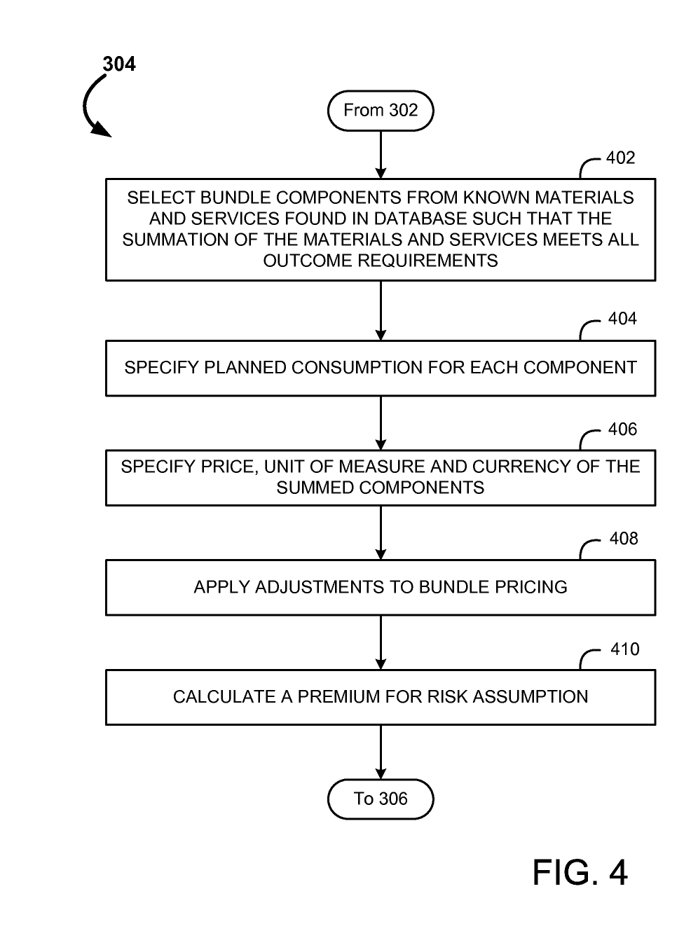

The system ten generates a bundle of goods and services which achieve the desired outcome (at 304). Progressing briefly to FIG. 4, a more detailed flow is presented for the activity of generating the bundle. Initially the bundle components are selected (at 402) from known materials and/or services (line items located in the database 114) such that the summation of the materials and services meet all outcome requirements. Again, the materials and services are known to have particular outputs for a given quantity. As such, the system may rapidly formulate a bundle that meets the vendor's needs in real time.

Next, the planned consumption of each component may be specified (at 404) in order to determine quantity adjustments. For example, if in our previous hypothetical, a 100 watt bulb lasts for 2000 hours, and the displays are illuminated 24 hours a day, the initial 200 bulbs would need replacement after approximately 83 days. If the desired outcome is to supply 200,000 lumens for 1 year, then the total requirements would be for approximately 880 bulbs over the duration of the contract (assuming 1000 lumens per bulb).

The price, unit of measure and currency of the summed components in the bundle are then specified (at 408). Then, adjustments may be applied to the bundle price. For example the manufacturer of light bulbs offers a 10% discount on orders of over 500 bulbs; this discount adjustment may be applied to the bundle to make the entire package more competitive. Likewise, the adjustment may be tied to a raw material index to account for fluctuations in the market for commodities. Additionally, adjustments up for specific components that are known to be in short supply may be applied, where desired.

Lastly, the premium for the assumption of the risk is calculated (at 410) and applied to the total bundle price. In our previous example, the retailer requires a set number of lumens to illuminate a display. Using traditional line item transactions the retailer would have to calculate out the number of bulbs, fittings, cable and manpower required to achieve their goal. The customer would then present the order to vendors and negotiations would follow. If the retailer miscalculated, the cost could jump in order to remedy the issue. Further, if something goes wrong (such as more bulbs burn out prematurely due to temperature swings), the retailer again assumes the burden of resolving the issue. In an outcome based transaction the retailer sheds all this risk and places it upon the vendor. The vendor has flexibility in how to achieve the desired outcome, but assumes the risk of ensuring it gets done according to expectations. The premium that is calculated may reflect this risk using known risk analysis techniques.

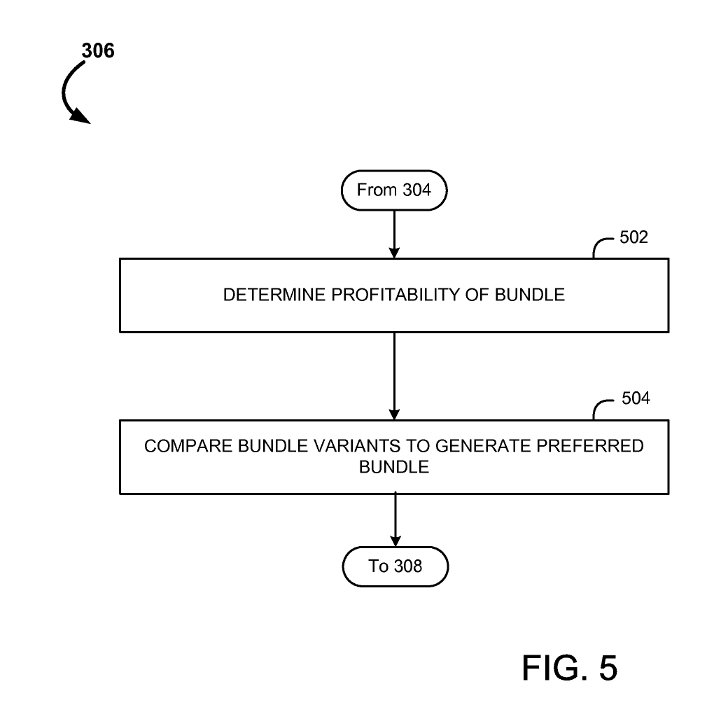

Returning now to FIG. 3, the price of the bundle is then evaluated (at 306). A more detailed description of this process is illustrated in relation to FIG. 5. Here, the profitability of the bundle is determined (at 502) by summing the profitability of each line item (after adjustment) and the premium. Next, the bundle is compared to other bundle variants (at 504) in order to determine the preferred bundle. Preferred bundles may be selected by a weighted function which balances the profitability of each bundle and the overall competitiveness of the bundle. In an ideal situation, one bundle would be lowest in cost and highest in margin thereby ideally suited for both the customer and the vendor. However, it is often the case that the lowest cost bundle and the most profitable bundle are not the same. The vendor clearly benefits more from the higher profit bundle; unless of course the transaction fails because the customer sources elsewhere. As such, the vendor often also considers the overall competitiveness of the bundle in order to determine which bundles are preferred and should be presented to the business management software 112. This selection may be manually performed by the vendor's salespeople, or may be automated through an objective function.

Returning to FIG. 3, the next step is to determine if additional bundles are desired (at 308). In some cases, depending upon the desired outcome, only a select few bundle options may be generated. However, in circumstances where a large number of line items can achieve the desired outcome, it may be possible that a very large number of bundles could be generated for a given outcome. In these cases, it may be desirable to generate a defined number of bundles for comparison by limiting line item combinations in order for the vendor to have a variety of options without being overwhelmed.

If additional bundles are needed, the process returns to 304 where another bundle is generated. New bundle generation may include populating a bundle from scratch, or may include duplicating an existing bundle which achieves the outcome and substitution one or more of its components with alternate materials or services. Additionally, bundle level details may be changed (i.e., output quantity), or component level details may be altered (i.e., quantities, or units of measure). Otherwise, if no additional bundle is desired, the process may progress to where the preferred bundle is provided (at 310) to the enterprise resource planning system for further negotiations and completion. Generally, the components of the bundle are not presented to the customer, and rather the outcome is provided for an aggregate bundle price. Of course, in alternate embodiments it may be desirable to provide the customer greater degrees of transparency into the bundle makeup and even pricing.

The bundle and/or components of the bundle are then monitored (at 312) for performance. As noted above this performance may be utilized to update the output values stored for each line item, and otherwise to assist in subsequent transactions.

### III. Examples

The following disclosure and associated figures will now be centered on a series of example screenshots which illustrate different operations of some embodiments of the outcome based pricing. Note that while specific and detailed screenshots are provided, these examples are intended to be illustrative in nature and are not intended to limit the scope of the disclosure to any particular embodiment. For example, other interface styles, content on each page and order of display to the users is entirely possible as is desirable for efficient usability of the system.

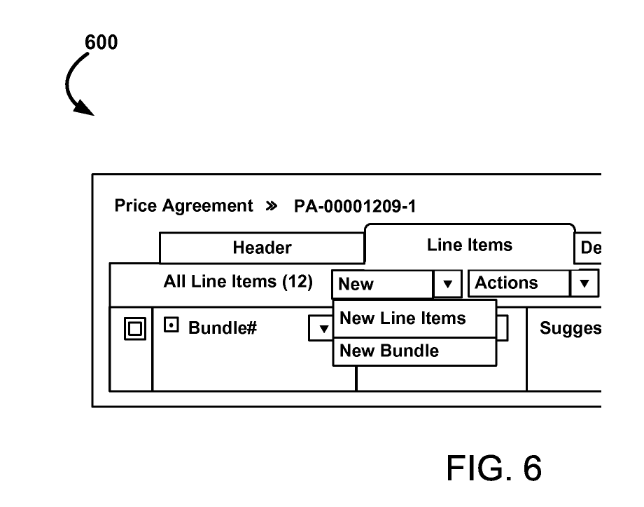

The example screenshots start at FIG. 6 which provides an example dashboard for the addition of a new bundle on a line item level, shown at 600. In this example, the line item tab is selected, and a new bundle is being selected from the drop down menu.

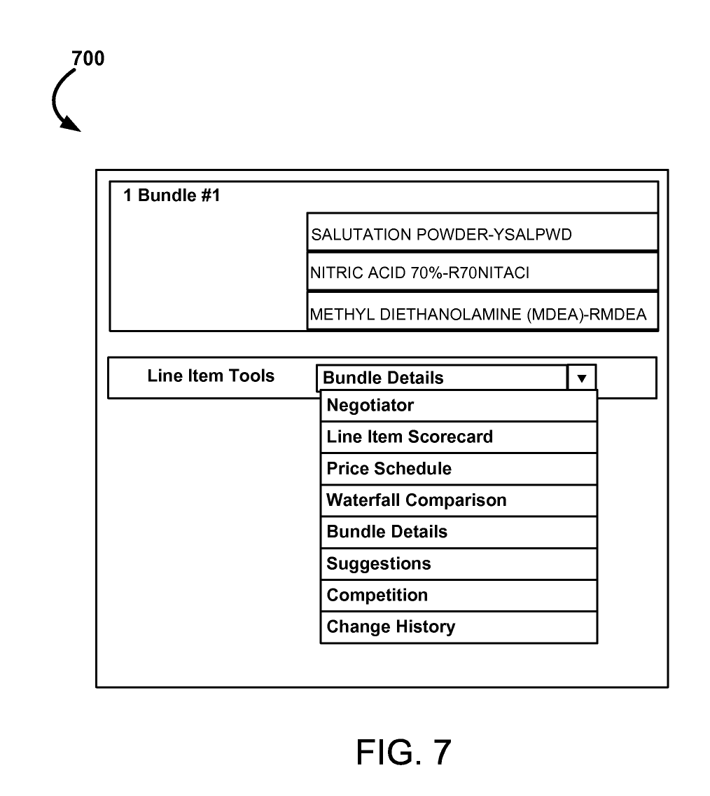

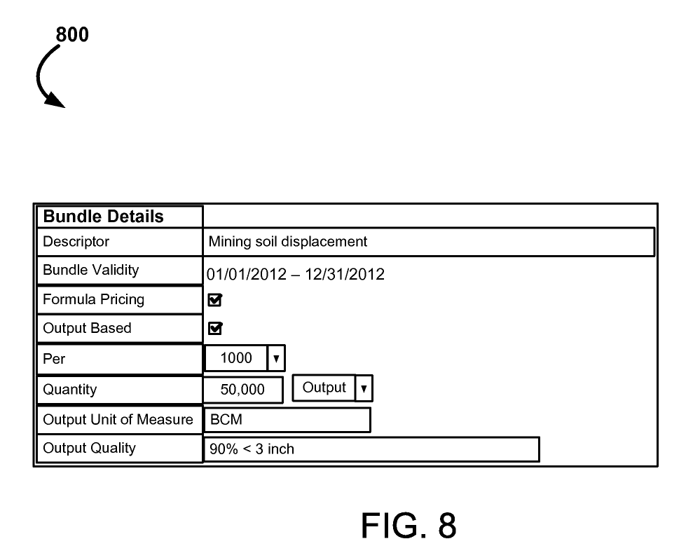

After the “new bundle” menu item has been selected, the user is directed to an interface where the bundle is initiated, shown at 700 of FIG. 7. A drop down menu for the line item tools is provided. The first option in this drop down menu is for the details of the bundle. Once selected the user is directed to a bundle details dashboard, shown at 800 of FIG. 8.

In the bundle details interface the user may input a descriptor for the bundle, validity time period, that the pricing is formula based and it is outcome based. Further the quantity of the outcome may be defined, as well as the unit of measure and quality of output. Alternatively, rather than the user inputting these bundle details, they may be directly received from the customer or negotiation system.

In this example screenshot, bundle details are presented for a mining operation where soil is to be displaced. Here the soil is specified as being 50,000 bank cubic meters (BCM refers to cubic meters of rock in place before disruption) of material removed, where the materials are 90% sized less than 3 inches in size. Of course alternate outputs may be defined, such as lumens in a particular wavelength of light, landings per specifically sized plane wheels, bandwidth size with a particular latency, etc.

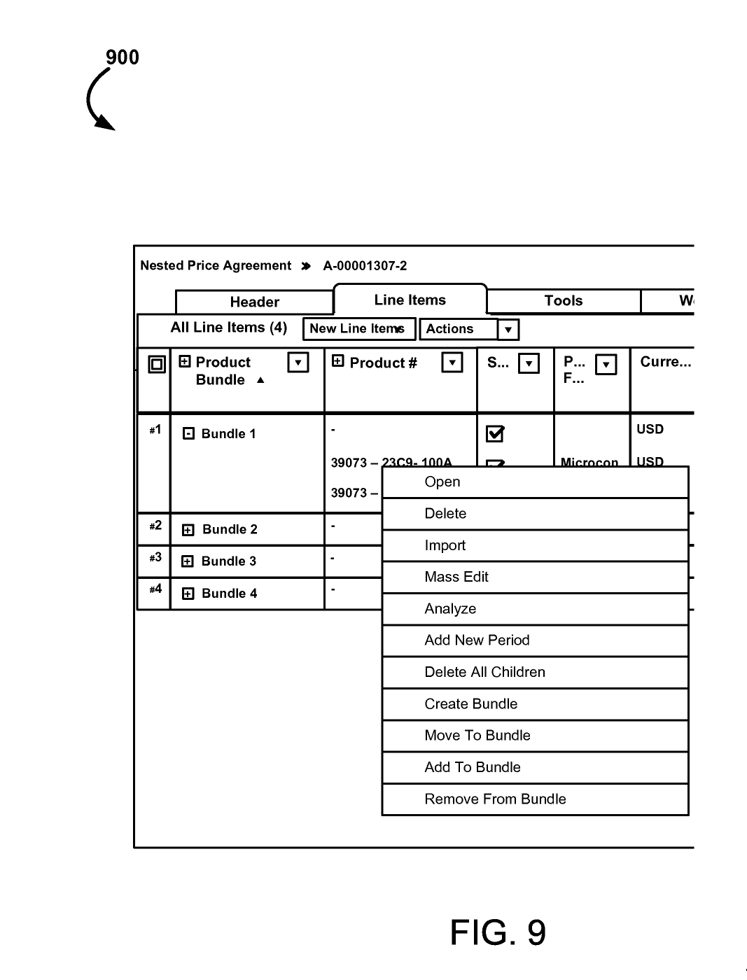

After bundle details have been defined and/or reviewed, the system may direct the user to a dashboard where the bundles are listed, as seen at 900 of FIG. 9. Here the individual bundles are listed with the ability to be expanded to show individual line item components if desired. Here the first bundle has been expanded and a particular line item has been selected by the user. When a bundle is selected, the user is presented a menu of options for it, including opening the bundle, deleting it, importing it, mass editing the bundles, analyzing the selected bundle, adding a record, deleting all the children of the bundle, creating a bundle, moving a line item to a bundle, adding a line item to a bundle, and removing a line item from the bundle.

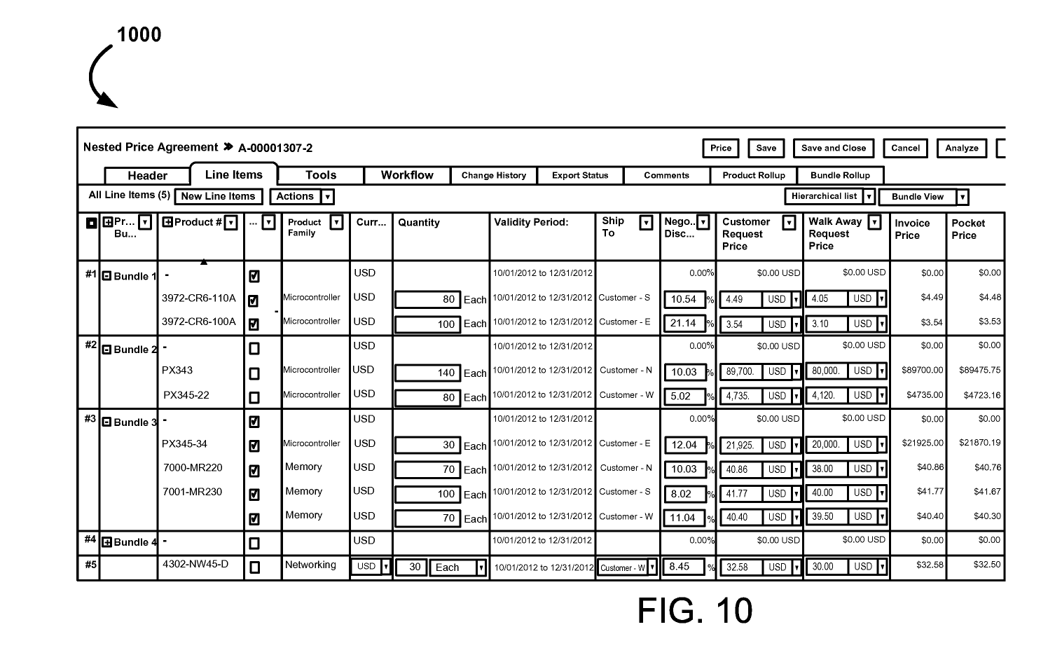

At FIG. 10, the summary of bundles and pricing of the bundles is illustrated at 1000. In this example screenshot four bundles for a network improvement are presented. Each bundle has a series of line items, including descriptors and currencies. In this particular example, the bundles are comprised of a combination of microcontrollers, memory and networking devices. Quantities for each line item are presented, as well as the period of validity. The shipping location is also presented, as well as negotiated discounts for ach component. Request price, walk away price, invoice price and pocket price are likewise illustrated for each line item in each bundle. Check toggle boxes are provided in order for the user to indicate which bundles are preferred given the pricing information. In this particular example, bundles one and three are checked as being preferred.

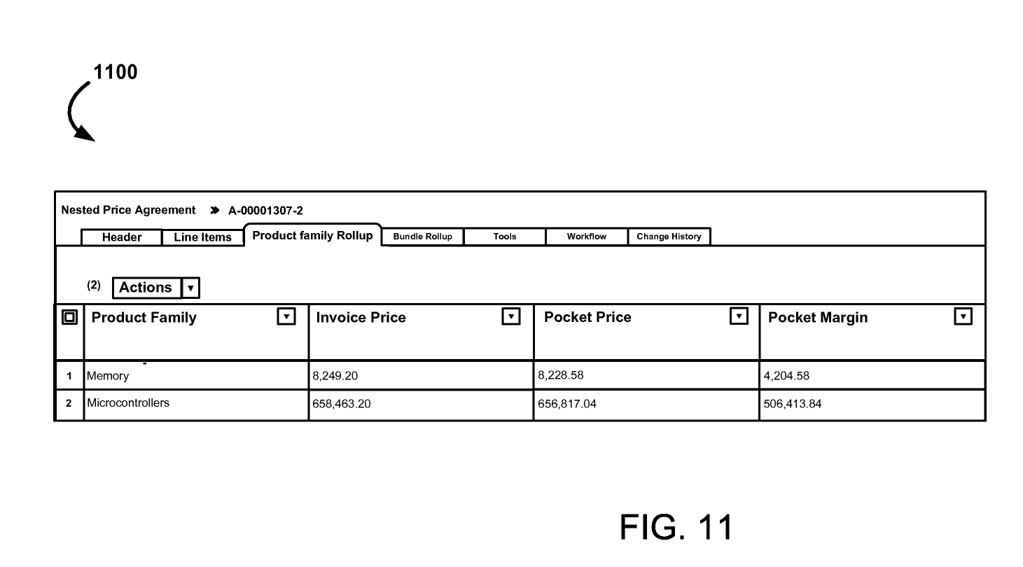

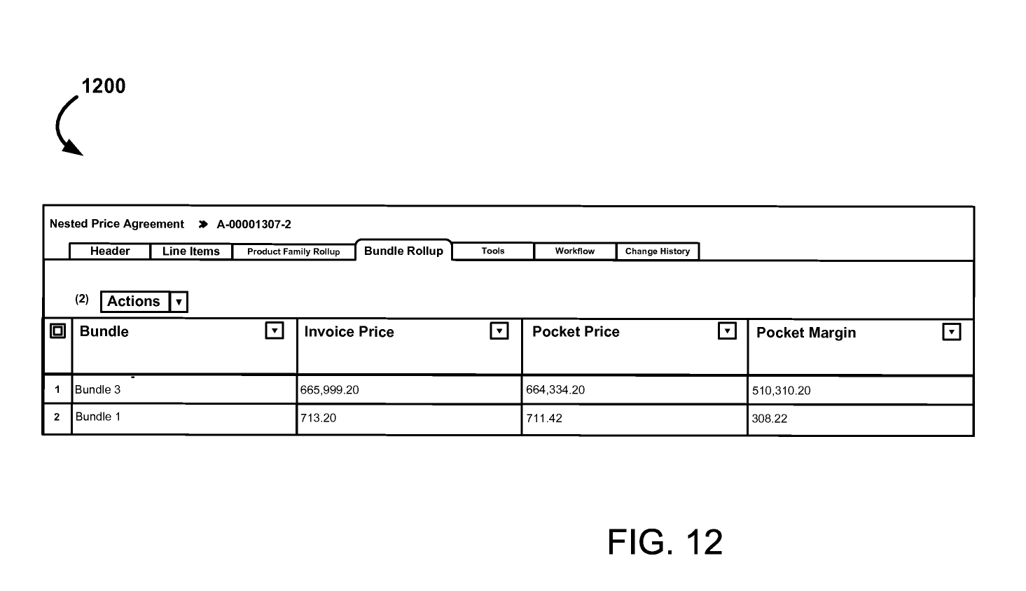

At FIG. 11 an agreement summary dashboard is presented, at 1100. Here the summary is provided by product families (microcontrollers and memory in the present example). This summary includes illustrating invoice price, pocket price and margin. In contrast, the summary may be presented for the bundles rather than by product families, as illustrated at FIG. 12 at 1200.

### IV. System Embodiments

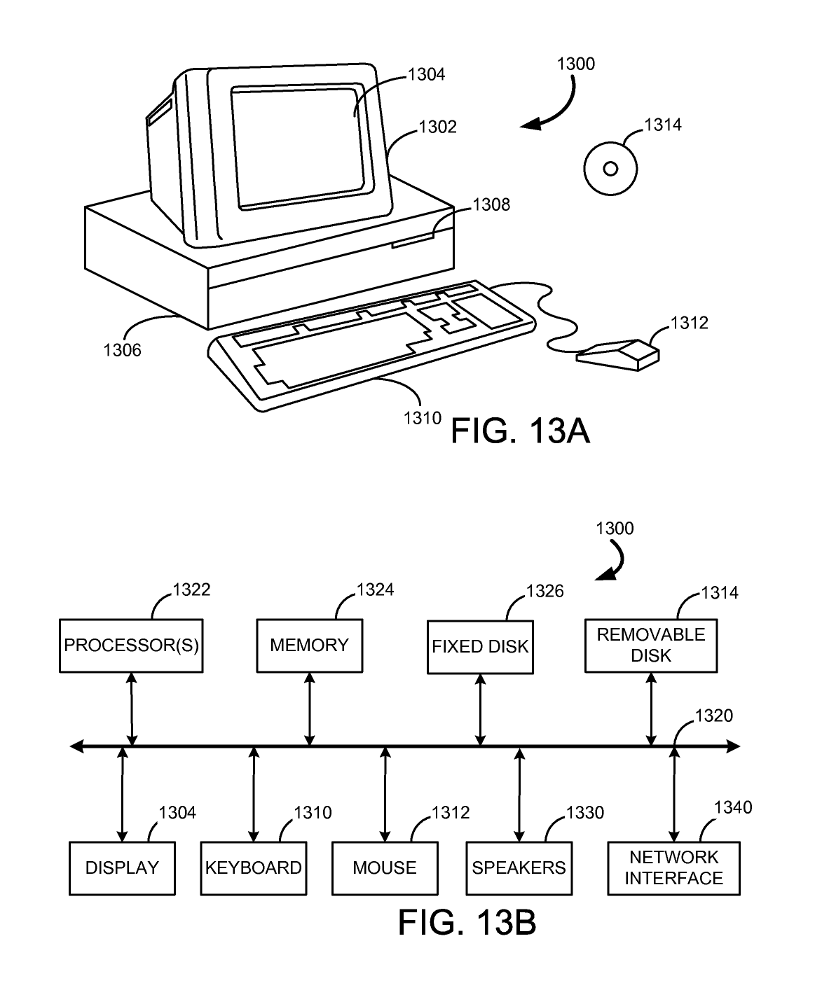

FIGS. 13A and 13B illustrate a Computer System 1300, which is suitable for implementing embodiments of the present invention. FIG. 13A shows one possible physical form of the Computer System 1300. Of course, the Computer System 1300 may have many physical forms ranging from a printed circuit board, an integrated circuit, and a small handheld device up to a huge super computer. Computer system 1300 may include a Monitor 1302, a Display 1304, a Housing 1306, a Disk Drive 1308, a Keyboard 1310, and a Mouse 1312. Disk 1314 is a computer-readable medium used to transfer data to and from Computer System 1300.

FIG. 13B is an example of a block diagram for Computer System 1300. Attached to System Bus 1320 are a wide variety of subsystems. Processor(s) 1322 (also referred to as central processing units, or CPUs) are coupled to storage devices, including Memory 1324. Memory 1324 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 1326 may also be coupled bi-directionally to the Processor 1322; it provides additional data storage capacity and may also include any of the computer-readable media described below. Fixed Disk 1326 may be used to store programs, data, and the like and is typically a secondary storage medium (such as a hard disk) that is slower than primary storage. It will be appreciated that the information retained within Fixed Disk 1326 may, in appropriate cases, be incorporated in standard fashion as virtual memory in Memory 1324. Removable Disk 1314 may take the form of any of the computer-readable media described below. Processor 1322 is also coupled to a variety of input/output devices, such as Display 1304, Keyboard 1310, Mouse 1312 and Speakers 1330. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor 1322 optionally may be coupled to another computer or telecommunications network using Network Interface 1340. With such a Network Interface 1340, it is contemplated that the Processor 1322 might receive information from the network, or might output information to the network in the course of performing the above-described Revenue Causality Analyzer 100. Furthermore, method embodiments of the present invention may execute solely upon Processor 1322 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In sum, the present disclosure provides systems and methods for outcome based pricing. Such systems and methods enable transactions to be performed based upon value added to the customer rather than on individual SKUs. Such systems promote efficiency and increased profits to the vendor.

While this invention has been described in terms of several embodiments, there are alterations, modifications, permutations, and substitute equivalents, which fall within the scope of this invention.

It should also be noted that there are many alternative ways of implementing the methods and systems of the present invention. Although sub-section titles have been provided to aid in the description of the invention, these titles are merely illustrative and are not intended to limit the scope of the present invention. It is therefore intended that the following appended claims be interpreted as including all such alterations, modifications, permutations, and substitute equivalents as fall within the true spirit and scope of the present invention.

1. A method for outcome based pricing, useful in conjunction with an enterprise resource planning system, the method comprising:
receiving a desired outcome for a deal;
generating a plurality of bundles of line items using a processor which each achieves the desired outcome, wherein the line items are selected from a plurality of known goods and services, and wherein each line item includes an output, further wherein a summation of the outputs for each of the bundles of line items achieves the desired outcome;
pricing each of the plurality of bundles of line items;
selecting a preferred bundle from the plurality of bundles based upon bundle profitability and competitiveness; and
outputting the preferred bundle of line items.

2. The method of claim 1, wherein the desired outcome includes a quantity value and a quality value.

3. The method of claim 1, wherein the desired outcome is received from a customer.

4. (canceled)

5. The method of claim 1, further comprising wherein each of the plurality of bundles is priced to determine invoice price, pocket price and margin.

6. The method of claim 5, further comprising comparing the pricing for each of the plurality of bundles to identify at least one preferred bundle.

7. The method of claim 6, wherein the at least one preferred bundle is identified by an objective function which weights profitability of each bundle and overall price of each bundle.

8. The method of claim 6, wherein the at least one preferred bundle is output to an enterprise resource management system.

9. The method of claim 1, further comprising monitoring the output bundle for performance.

10. The method of claim 9, further comprising updating the output of each line item in response to the monitored performance.

11. A system for outcome based pricing, useful in conjunction with an enterprise resource planning system, the outcome based pricing system comprising:
an interface configured to receive a desired outcome for a deal;
a bundle generator configured to generate a plurality of bundles of line items using a processor which each achieves the desired outcome, wherein the line items are selected from a plurality of known goods and services, and wherein each line item includes an output, further wherein a summation of the outputs for each of the bundles of line items achieves the desired outcome;
a price evaluator configured to price each of the plurality of bundles of line items;
an optimizer configured to select a preferred bundle from the plurality of bundles based upon bundle profitability and competitiveness; and
an interface configured to output the preferred bundle of line items.

12. The system of claim 11, wherein the desired outcome includes a quantity value and a quality value.

13. The system of claim 11, wherein the desired outcome is received from a customer.

14. (canceled)

15. The system of claim 11, wherein the bundle price evaluator prices each of the plurality of bundles to determine invoice price, pocket price and margin.

16. The system of claim 15, wherein the bundle price evaluator is further configured to compare the pricing for each of the plurality of bundles to identify at least one preferred bundle.

17. The system of claim 16, wherein the at least one preferred bundle is identified by an objective function which weights profitability of each bundle and overall price of each bundle.

18. The system of claim 16, wherein the interface outputs the at least one preferred bundle to an enterprise resource management system.

19. The system of claim 11, further comprising a bundle monitor configured to monitor the output bundle for performance.

20. The system of claim 19, wherein the bundle monitor is further configured to update the database for the output of each line item in response to the monitored performance.
